(19) United States
(12) Patent Application Publication
(10) Pub. No.: US 2008/0263099 A1
(43) Pub. Date: Oct. 23, 2008

(54) Affinity based social agent

(76) Inventors: Susann M. Brady-Kalnay, Cleveland, OH (US); Stephen BRADY, Columbus, OH (US)

Correspondence Address: KRAGULJAC & KALNAY, 4700 ROCKSIDE ROAD, SUMMIT ONE, SUITE 510, INDEPENDENCE, OH, 44131, US

(21) Appl. No.: 12/080,881

(22) Filed: Apr. 7, 2008

Related U.S. Application Data
(60) Provisional application No. 60/925,356, filed on Apr. 19, 2007.

(51) Int. Cl. G06F 17/00; G06F 17/30

(52) U.S. Cl. 707/104.1; 707/E17.009

(57) ABSTRACT

Systems and methods associated with selectively initiating a social interaction based on affinity between personal electronic devices are described. One example system includes a data store to store playable content and a content organization logic to create a playlist of playable content. The system may include a communication circuit to communicate with a remote PED. The circuit may acquire information describing a playlist in a remote PED. The system may include a social agent logic to determine a degree of affinity between the PED and the remote PED. The degree of affinity may be based, at least in part, on a comparison of the playlist associated with the PED and a playlist associated with the remote PED.

### CROSS REFERENCE TO RELATED APPLICATIONS

This application claims the benefit of U.S. Provisional Application 60/925,356 titled iSocialize, filed Apr. 19, 2007, by the same inventors.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Personal music players (e.g., MP3 players) are ubiquitous. For example, an early 2007 news story reported the sale of the 100 millionth unit of a popular MP3 player. MP3 players are now found in mobile telephones, sunglasses, standalone personal electronic devices, automobiles, clothing, and so on. While MP3 is a popular format, music may also be played from files stored in other formats. Other personal electronic devices (PEDs) are also omnipresent. For example, personal video game players, personal video players, personal electronic mail machines (PEMPs) (e.g., Blackberry®) and so on, have become a part of everyday life.

A typical personal music player (PMP) may be individualized by its user. For example, out of the millions of songs available, a user may store only a selected set of songs on their PMP. These songs may be downloaded from a network, copied from a CD, and so on. This set of songs may be referred to as a playset. Regardless of how a song is acquired, a user must make a conscious decision to load their player with their playset. Songs may have associated metadata that describes, for example, a title, an artist, a recording date, a genre, and so on. Similarly, a personal game device (PGD) or personal video device (PVD) may have a customized “playlist” of games, movies, characters, and so on.

Users may organize a playset into subsets of songs, videos, games, characters, text passages, photos, and so on depending on the type of content stored on the PED. The organizations may be referred to as playlists. Some PEDs provide applications to facilitate this organizing. Once again, a conscious decision is made by the user concerning how to organize their playset into their playlists. An application may be used to create different playlists that are intended for different activities. For example, a first playlist may be created for jogging, another for a party, another for mood-setting, and so on.

Some automated social agents have attempted to mine information concerning a playset, playlists, and/or metadata available in a PMP. However, these social agents have typically been directed at recommending other songs a user may like, identifying advertising to present to a user, and so on.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example system associated with an affinity based social agent.

FIG. 2 illustrates an example method associated with an affinity based social agent.

FIG. 3 illustrates an example method associated with determining a degree of affinity between users of personal electronic devices.

FIG. 4 illustrates an iPod configured with an affinity based social agent logic.

### DETAILED DESCRIPTION

Example systems and methods provide automated social agents that extend the functionality of PEDs (e.g., PMPs, PGPs, PVPs). These automated social agents facilitate selectively providing additional functionality in a PED based on comparing and analyzing playsets, playlists, and/or metadata available in PMPs. Example systems and methods may use an application to create a social-interaction playlist(s). Different playlists may be created for different purposes. In one example a user may be looking for a workout partner. In another example a user may be looking for a date. In yet another example, a user may simply be looking for someone to go dancing, preferably someone who likes the same kind of music.

The following includes definitions of selected terms employed herein. The definitions include various examples and/or forms of components that fall within the scope of a term and that may be used for implementation. The examples are not intended to be limiting. Both singular and plural forms of terms may be within the definitions.

ASIC: application specific integrated circuit.

CD: compact disk.

CD-R: CD recordable.

CD-RW: CD rewriteable.

DVD: digital versatile disk and/or digital video disk.

LAN: local area network.

RAM: random access memory.

ROM: read only memory.

PROM: programmable ROM.

EPROM: erasable PROM.

EEPROM: electrically erasable PROM.

WAN: wide area network.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Signal”, as used herein, includes but is not limited to, electrical signals, optical signals, analog signals, digital signals, data, computer instructions, processor instructions, messages, a bit, a bit stream, or other tangible things that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

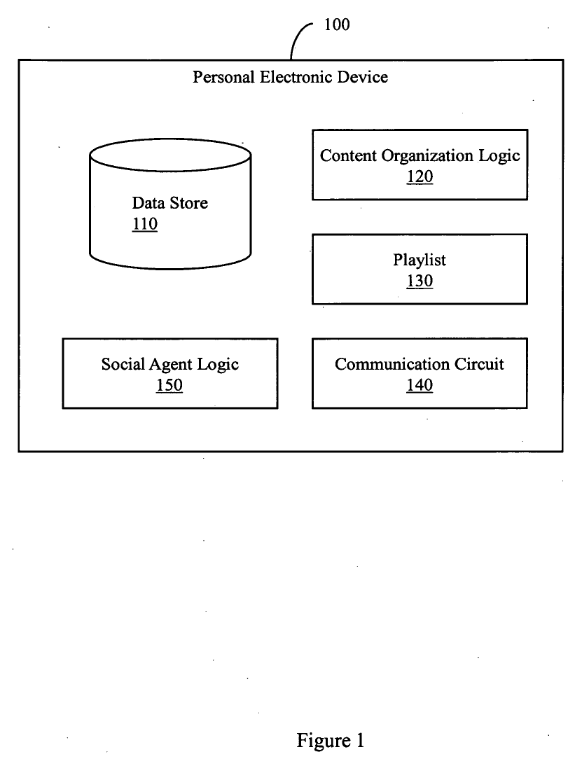

FIG. 1 illustrates an example system associated with an affinity based social agent. In one example, the affinity based social agent may determine a degree of affinity between users of personal electronic devices. The system may reside inside a personal electronic device (PED) 100. PED 100 may include a data store 110 to store a set of content items that can be played by the PED. The content items may be, for example, songs, movies, text passages, and so on. In one example, PED 100 may be an MP3 player and thus the content items may be songs. In a different example the PED may be a personal video player (PVP) and thus the content items may be videos. In yet another example the PED may be a personal game player (PGP) and thus the content items may be video games. In still yet another example, the PED may be a personal database viewer (PDBVP) and thus the content items may be database records.

PED 100 may also include a content organization logic 120 that is to create a playlist 130 from members of the set of content items. In different examples, the playlist 130 may be built based on manual inputs from a user of PED 100, from automated analysis of attributes of content items, and so on. In one example, the content organization logic 120 is to automatically select a member of the set of content items to be included in the playlist 130 based, at least in part, on metadata associated with the member. The metadata may include, for example, information identifying an artist, a title, a unique item identifier, a genre, a theme, a beat, a user-defined data, a frequency of play, how recently an item was played, and so on.

PED 100 may also include a communication circuit 140 to communicate with a remote PED. In one example, the communication circuit 140 is to facilitate wireless communication between PEDs. Thus, the communication circuit 140 may be, for example, a Wi-Fi® circuit, a Bluetooth® circuit, a cellular telephone circuit, and so on.

PED 100 may also include a social agent logic 150. Social agent logic 150 is to determine a degree of affinity between PED 100 and a remote PED. The degree of affinity may be based, at least in part, on a comparison of playlist 130 and a playlist associated with a remote PED. Social agent logic 150 may selectively provide a signal associated with initiating a social interaction upon determining that the degree of affinity exceeds a threshold. In one example, the comparison of the playlist 130 and the playlist associated with the remote PED includes determining a number of matching items in the two playlists being compared, a number of mismatching items in the two playlists being compared, a percentage of overlap between items in the two playlists being compared, a measure of how recently matching items in the two playlists have been played, and/or a measure of how frequently matching items in the two playlists have been played. In one example, the social agent logic 150 may include a social mode disable logic to selectively block whether affinity is determined, whether a social interaction is to be initiated, and so on.

The degree of affinity may also be geographically based. Thus, in one example, the degree of affinity may depend, at least in part, on a distance between the PED 100 and the remote PED. For example, the degree of affinity may depend on whether a remote PED is determined to be within a local radius, within a specifically geographical region, and so on. In another example, the degree of affinity may depend on geographical basis as determined by languages configured in the PED 100 and a remote PED. If the PED 100 has a default language of English and the remote PED has a default language of French, then the degree of affinity may be lower based on this geographical basis than if both PEDs had French as their default language. Thus, the control signal produced by social agent logic 150 may include geographical location information identifying the location of the remote PED and/or other geographic information.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methods are shown and described as a series of blocks, it is to be appreciated that the methods are not limited by the order of the blocks, as some blocks can occur in different orders and/or concurrently with other blocks from that shown and described. Moreover, less than all the illustrated blocks may be required to implement an example method. Blocks may be combined or separated into multiple components. Furthermore, additional and/or alternative methods can employ additional, not illustrated blocks.

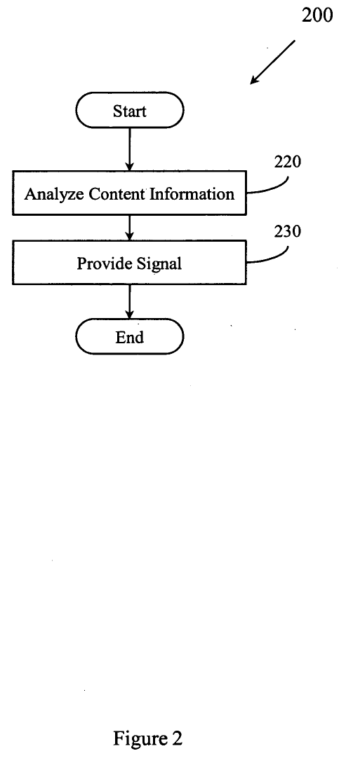

FIG. 2 illustrates an example method 200 associated with an affinity based social agent. In one example the social agent may determine a degree of affinity between users of personal electronic devices. Method 200 may be performed in a local PED to determine a degree of affinity between the local PED and a remote PED. Method 200 includes, at 220, analyzing, in the local PED, information associated with playable content located in the remote PED. The information associated with the playable content may include, for example, a set of artists included in the playable content, a set of titles included in the playable content, a set of unique identifiers associated with the playable content, a set of user-defined data, a measure of how frequently the playable content is played, and a measure of how recently the playable content was played. Thus, the degree to which the playable content located in the remote PED satisfies a criteria associated with initiating a social interaction may depend, at least in part, on determining a number of items in the playable content that match items located in the local PED, a number of items in the playable content that do not match items located in the local PED, a percentage items in the playable content that match items located in the local PED, a ratio of items in the playable content that match items located in the local PED in light of items in the playable content that do not match items located in the local PED, a measure of how recently a matching item in the playable content has been played, and/or a measure of how frequently a matching item in the playable content has been played.

Method 200 may also include, at 230, providing a signal to the local PED. The signal may describe the degree to which the playable content located in the remote PED satisfies a criteria associated with initiating a social interaction. In one example, a set of default criteria may be available in a PED while in another example a user may set the criteria.

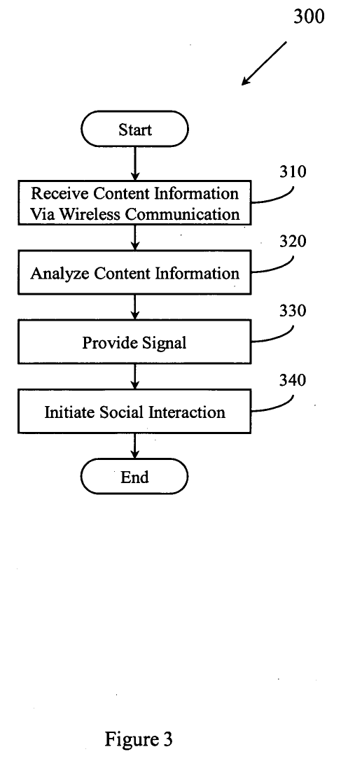

FIG. 3 illustrates an example method 300 associated with determining a degree of affinity between users of personal electronic devices. Method 300 includes some actions similar to those described in connection with method 200 (FIG. 2). For example, method 300 includes analyzing playable content at 320 and providing a signal at 330. However, method 300 includes additional actions.

For example, method 300 includes, at 310, receiving the information associated with the playable content located in the remote PED through a wireless communication channel. The wireless communication channel may be, for example, a Wi-Fi® channel, a Bluetooth® channel, and so on.

Method 300 also includes, at 340, initiating a social interaction based, at least in part, on the signal describing the degree to which the playable content located in the remote PED satisfies the criteria associated with initiating the social interaction.

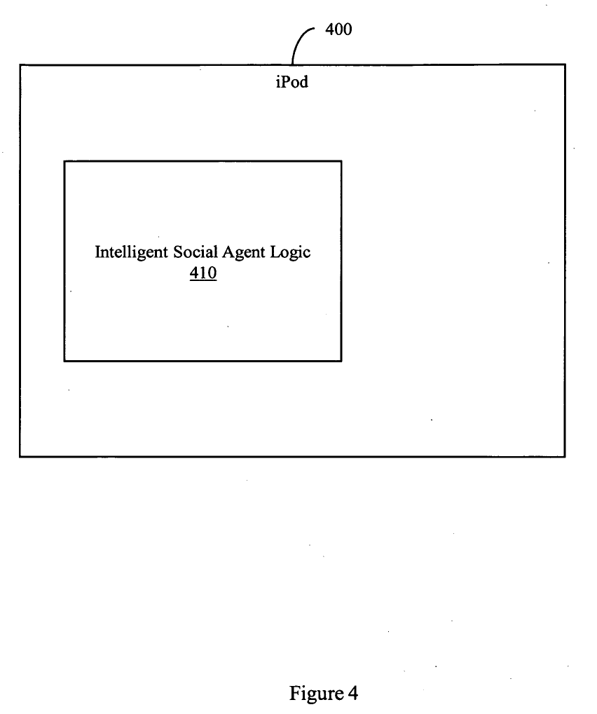

FIG. 4 illustrates an iPod® 400 configured with an affinity based social agent logic 410. The intelligent social agent logic 410 may be configured to initiate a social interaction between a user of the iPod® and a user of a second iPod®. While an iPod is described, it is to be appreciated that other devices (e.g., iPhone®, MP3 player, PED) may be similarly configured. The social interaction may be, for example, an email exchange, a text message exchange, a phone call, an acquisition of playable content, and so on. Whether the interaction is initiated may depend, at least in part, on a degree of affinity between a playlist on the iPod® and a playlist on the second iPod®. The degree of affinity may be computed by the intelligent social agent logic 410. The degree of affinity may depend, for example, on similarities between playlists on two different iPods®. The degree of affinity may also depend, for example, on how recently similar tracks in similar playlists have been played.

Example social agents may facilitate new social interactions based on information available in a PMP. The social agents may be configured by applications and/or manually. Social agent behavior may be determined, at least in part, by playlists produced by an application. Social agent behavior may also be determined, at least in part, by user enabling and/or disabling a social mode associated with the PED.

In one example, a PMP may be configured with a communication logic. This communication logic may be configured to communicate in different manners. For example, the communication logic may be configured to communicate with a server on a network, from MP3 player to MP3 player, from PGP to PGP, from PVP to PVP, and so on. Regardless of the communication method, example social agents may be configured to have a first PMP search for other PMPs having playsets, playlists, and/or metadata that correspond to the playsets, playlists, and/or metadata associated with the first PMP according to a selection algorithm(s). In one example, the first PMP may perform the search while in another example the first PMP may cause the search to be performed. Searches may include single point searches, master/servant searches, collaborative searches, and so on. Similarly, example social agents may control a first PVP or PGP to communicate with other similar devices and to determine a degree of affinity between “playsets” resident on the device(s).

A search of playsets may indicate to a PED (e.g., PMP) user that the potential for a compatible social interaction exists. The PMP may then provide the user with options concerning whether and/or how to initiate the social interaction. By way of illustration, a first user having a PMP may enter a room (e.g., coffee shop, classroom, party). The first user may selectively control their PMP to initiate a search for other PMP players in the room whose stored playset, playlists, and/or metadata may indicate that the first user may be interested in interacting with (e.g., meeting, calling, avoiding) the user of the PMP having the “matching” data. The search may be based, for example, on matching playsets, on matching playlists, on matching metadata, and so on. Different matching algorithms may be employed to determine the similarity and/or differences between compared data. While matching songs are described, it is to be appreciated that matches between recently watched/rated movies, recently read/rated books, recently played/rated games, and so on may also be compared between PEDs, with the comparison leading to the identification of a potential social interaction. In one example, a user may determine whether to expose their recently experienced content.

To continue the illustration, the first user may have a playset that includes N songs from a certain artist. Thus, the first user may have configured their PMP to seek out other PMPs having at least M songs by the same artist. Matching algorithms may be based on metadata, additional data, and other attributes. For example, matching algorithms may consider the number of matching songs, the number of not matching songs, the number of matching artists, the number of not matching artists, the relative numbers of songs in a certain genre, how recently matching songs were played, how frequently matching songs were played, how recently a non-matching song was played, how frequently a non-matching song was played, and so on. In one example, matching algorithms are pre-loaded by the provider of the PMP while in another example matching algorithms may be configured by the user. Parameters on which a search may be configured may include, for example, a physical range (e.g., 100 feet, this room, this cell coverage area), a match percentage, a mismatch percentage, and so on. In this way, a PMP user may determine whether there is anyone in the room they may want to meet and/or avoid.

Consider a user who loves a certain artist (e.g., Chris Daughtry) and a certain type of music (e.g., Rock). This user may seriously dislike another artist (e.g., Pavarotti) and another type of music (e.g., Opera). This user may configure their PMP to identify whether there are any other people in the configured range who like the loved artist or who like the hated artist. The identification may depend on the presence of that artist's songs on a remote device, the number of that artist's songs on a remote device and/or on a ratio of that artist's songs to other artist's songs on the remote device. This may provide the PMP user with information concerning whether they have found “their crowd” and more particularly whether they may find “their soul mate.”

In one example, a comparison of playlists may be formatted like a query (e.g., SQL query). Thus, the degree of affinity may be based on the result of performing a comparison that includes multiple elements. For example, the degree of affinity may be based on a score that indicates that number of songs from a first artist in a playlist, and the number of songs from a second artist in a playlist, and whether the playlist includes any songs from a liked artist, and whether the playlist includes any songs from a disliked artist, and whether the playlist includes any songs from a liked genre, and whether the playlist includes any songs from a disliked genre, and whether any songs from a specified artist have been played within a specified time period, and so on. While the conjunctive “and” has been used in the example, it will be appreciated that a score may depend on a combination of conjunctively and disjunctively joined elements.

Online dating sites are one example of how users choose to interact with each other to find their “soul mate”. These online dating sites tend to have users answer questions about themselves and about what they are looking for in a date. Rather than force potential dates to answer questions, (to which they may lie), a PMP player-based social agent may identify people of interest based on their playsets, playlists, and/or metadata. While music playlists have been described, consider a different type of matching in PEDs. Consider handheld gaming consoles on which users may play a massively parallel multiplayer real time game (e.g., World of Warcraft). Not all players like playing with all other players. In fact, some players severely dislike playing with certain types of other players (e.g., players who consistently “frag” their own team members). Thus, an affinity based social agent ready PGP may interrogate remote PGPs that are in range for a social interaction to determine whether to engage in a social interaction.

A PMP user may not wish to constantly broadcast their PMP data or to constantly seek out matching PMP data. Thus, in on example, a PMP player may include a logic to allow a user to turn “social mode” on and/or off. Similarly, a PMP user may wish to restrict the range to which their PMP data is distributed. Thus, in one example, a PMP player may include a logic to allow a user to configure the range (e.g., this room, x feet, x miles, this campus) of their PMP social interactions. In one example, the range may be limited to the range attainable through a defined protocol (e.g., Wi-Fi®, Bluetooth®, cellular telephone).

While playsets have been described so far, it is to be appreciated that other personal electronic devices may also store data that intelligent social agents may share and/or examine and thus upon which social interaction determinations may be made. For example, users may have personal movie players, book players, game players, and so on. Thus, the content upon which the intelligent social agents may act may include movies and/or information associated with movies, music and/or information associated with music, television shows and/or information associated with television shows, books, podcasts and/or information associated with podcasts, games, game characters, roles played, and so on. This content may be searchable on attributes including, but not limited to, its metadata (e.g., title, author, genre), its organization (e.g., membership in playlist, membership in “favorites” list), its location (e.g., range), frequency of play, how recently it was played, and so on.

Additionally and/or alternatively, a PMP or other personal electronic device (PED) may be configured with information a user explicitly programs into their PED for the purpose of participating in intelligent social agent mediated interactions. For example, a user may program their PED to indicate their willingness to meet people, attributes for which they are looking, and attributes they wish to advertise. In a “speed-dating” environment, rather than physically rotating through a set of potential dates, “daters” could first program their PEDs and then be guided to other similarly programmed PEDs based on the intelligent social agents performing PED criteria matching. For example, a person with an MP3 player standing in a taxi line at a busy airport (e.g., Las Vegas) may program their MP3 player to indicate that they are searching for someone traveling to the same location (e.g., Bellagio). In this way the MP3 player may be used to facilitate a match that may allow users to split a taxi fare. While an MP3 player is described, it is to be appreciated that other PEDs (e.g., Blackberry®) may more commonly be employed in this type of social interaction.

The possible social interactions associated with an intelligent social agent performing matching on PEDs are numerous. In one example, a user may have a dedicated social interaction device whose purpose is to support the intelligent social agent. This type of device may be useful in environments like a conference, a trade show, and so on, where people looking for certain services may wish to broadcast their information to people who may be looking to provide certain services. In this way sales leads may be met by sales people based on intelligent social agents performing PED based criteria matching. In these different environments, the “playlists” may not be lists of metadata annotated music but may be sets of other metadata annotated data (e.g., recent sales, recent purchases, email content).

In one example, the social interaction may include sharing content and/or acquiring content. For example, when a “match” is made, it may be determined that one PED currently has content upon which the match was predicated and that the other PED does not. Thus, the social interaction may include sharing the content. In one example, the PEDs may determine whether both are subscribers to a licensed music sharing service. If so, the sharing may occur. If not, the sharing may be blocked. In another example, the sharing may include acquiring the content. If the PED determines that the content upon which the match is not currently loaded on the PED, then the PED may communicate with a remote site (e.g., music store, remote library) to acquire the content.

To facilitate “making the connection”, a PED (e.g., PMP) may be configured to send and/or receive a notification upon determining that a potential social interaction is possible. For example, once an MP3 player has been identified as storing matching information and as being in range, then a user may be given an option to selectively initiate an electronic communication. For example, a text message may be sent to the matching PED, a mobile telephone call may be sent to the matching PED, an indicator may be activated on the matching PED, and so on. In this way the two (or more) users whose matching criteria are satisfied may be notified that there is another person in range with data that satisfied the intelligent social agent matching criteria. Once again the type and nature of communication may be pre-configured and/or configurable. The method and apparatus through which the communication is carried out (e.g., Wi-Fi®, Bluetooth®, telephony, cellular telephony) may also be configurable and/or selectable.

In one example, a user may simply be notified that there is a potential match nearby. In another example, a user may be given the option to send a text message to the matching user. In another example, both users may be notified that a potential match exists and given the option to share a second (e.g., more personal) set of data upon which additional matching can be made. For example, a user may be provided with a link to an electronic repository (e.g., mySpace® page, affinity based social agent profile) so that further analysis can be undertaken before the social interaction occurs. This may also provide security, whereby a person about to enter into a social interaction based on PMP-based search and match can forward information (e.g., to a friend) about the person with whom they are about to meet. Additionally, a user may be given an option about whether to transmit their photo to the matching device and/or to receive a photo from a matching device. Thus, PEDs may be configured to selectively push and/or pull information from a device that has satisfied a matching criteria.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A personal electronic device (PED), comprising:
a data store to store a set of content items that can be played by the PED;
a content organization logic to create a playlist from members of the set of content items;
a communication circuit to communicate with a remote PED; and
a social agent logic to determine a degree of affinity between the PED and the remote PED based, at least in part, on a comparison of the playlist associated with the PED and a playlist associated with the remote PED, and to selectively provide a signal associated with initiating a social interaction upon determining that the degree of affinity exceeds a threshold.

2. The PED of claim 1, where the PED is one of, an MP3 player, a personal video player (PVP), a personal game player (PGP), a personal email player (PEP), and a personal database viewer (PDBVP), and the content items are one or more of songs, videos, video games, emails, and database records.

3. The PED of claim 1, where the PED is one of, an iPod®, an iPhone®, and a Blackberry®.

4. The PED of claim 1, where the social agent logic is to acquire a member of the set of content items based, at least in part, on the degree of affinity.

5. The PED of claim 1, where the social agent logic includes a social mode disable logic to selectively block one or more of, determining a degree of affinity, and initiating a social interaction.

6. The PED of claim 1, where the content organization logic is to automatically select a member of the set of content items to be included in a playlist based, at least in part, on metadata associated with the member.

7. The PED of claim 6, where the metadata includes information identifying one or more of, an artist, a title, a unique item identifier, a genre, a theme, a beat, a user-defined data, a frequency of play, and how recently an item was played.

8. The PED of claim 6, where the metadata includes information identifying an artist, a title, a unique item identifier, a frequency of play, and how recently an item was played.

9. The PED of claim 1, where the communication circuit is to communicate with the remote PED using wireless communication.

10. The PED of claim 1, where the communication circuit is one of, a Wi-Fi® circuit, a Bluetooth® circuit, and a cellular telephone circuit.

11. The PED of claim 1, where the comparison of the playlist associated with the PED and the playlist associated with the remote PED includes determining one or more of, a number of matching items in the two playlists being compared, a number of mismatching items in the two playlists being compared, a percentage of overlap between items in the two playlists being compared, a measure of how recently matching items in the two playlists have been played, and a measure of how frequently matching items in the two playlists have been played.

12. The PED of claim 1, where the degree of affinity depends, at least in part, on a distance between the PED and the remote PED.

13. The PED of claim 1, where the social interaction involves one or more of, communicating an email, communicating a text message, and placing a telephone call.

14. The PED of claim 1, where the control signal includes geographical location information identifying the location of the remote PED.

15. A computer-readable medium storing computer-executable instructions that when executed by the computer cause the computer to perform a method, the method, comprising:
analyzing, in a local PED, information associated with playable content located in a remote PED; and
providing a signal to the local PED describing the degree to which the playable content located in the remote PED satisfies a criteria associated with initiating a social interaction.

16. The computer-readable medium of claim 15, including receiving the information associated with the playable content located in the remote PED through a wireless communication channel.

17. The computer-readable medium of claim 16, where the information associated with the playable content includes one or more of, a set of artists included in the playable content, a set of titles included in the playable content, a set of unique identifiers associated with the playable content, a set of user-defined data, a measure of how frequently the playable content is played, and a measure of how recently the playable content was played.

18. The computer-readable medium of claim 17, where the degree to which the playable content located in the remote PED satisfies a criteria associated with initiating a social interaction depends, at least in part, on determining one or more of, a number of items in the playable content that match items located in the local PED, a number of items in the playable content that do not match items located in the local PED, a percentage items in the playable content that match items located in the local PED, a ratio of items in the playable content that match items located in the local PED in light of items in the playable content that do not match items located in the local PED, a measure of how recently a matching item in the playable content has been played, and a measure of how frequently a matching item in the playable content has been played.

19. The computer-readable medium of claim 18, including initiating a social interaction based, at least in part, on the signal describing the degree to which the playable content located in the remote PED satisfies the criteria associated with initiating the social interaction.

20. The computer-readable medium of claim 19, where the social interaction includes acquiring a piece of playable content.

21. An iPod®, comprising:
an intelligent social agent logic configured to initiate a social interaction between a first user of the iPod® and a second user of a personal electronic device based, at least in part, on a degree of affinity between a playlist on the iPod® and a playlist on the personal electronic device.

22. A Blackberry®, comprising:
an intelligent social agent logic configured to initiate a social interaction between a first user of the Blackberry® and a second user of a personal electronic device based, at least in part, on a degree of affinity between a playlist on the Blackberry® and a playlist on the personal electronic device, where the playlist depends, at least in part, on a set of emails stored in the Blackberry®.

23. An iPhone®, comprising:
an intelligent social agent logic configured to initiate a social interaction between a first user of the iPhone® and a second user of a personal electronic device based, at least in part, on a degree of affinity between a playlist on the iPhone® and a playlist on the personal electronic device.
